(19) United States
(12) Patent Application Publication
(10) Pub. No.: US 2015/0051318 A1
(43) Pub. Date: Feb. 19, 2015

(54) ROLL COVER PRODUCTION METHOD AND ROLL COVER

(71) Applicant: VOITH PATENT GMBH, HEIDENHEIM (DE)

(72) Inventors: Franz Grohmann, Payerbach (AT); Martin Breineder, Natschbach (AT); Thomas Breineder, Natschbach (AT)

(21) Appl. No.: 14/389,422

(22) PCT Filed: Mar. 22, 2013
(86) PCT No.: PCT/EP2013/056072

§ 371 Date: Sep. 30, 2014

(30) Foreign Application Priority Data
Mar. 30, 2012 (DE) 102012205227.5

(51) Int. Cl. D21G 1/00; C08J 3/20

(52) U.S. Cl. CPC D21G 1/0073; C08J 3/203; C08J 2363/00; C08J 2375/04
USPC 523/451; 523/400; 524/589; 523/456; 523/466; 524/114; 524/539; 524/444; 524/442; 524/424; 523/468; 523/458; 524/413; 524/417; 524/423

(57) ABSTRACT

A roll cover is produced, in particular for use in a machine for producing and/or processing a fibrous web such as a web of paper or cardboard. The roll cover includes least one layer of a resin matrix that is filled with at least one particulate filler. The filler particles are produced in a polymer component of the resin matrix and/or introduced into the resin matrix from a dispersion via matrix exchange.

The invention relates to a method of producing a roll cover for use in a machine for producing and/or surface finishing a fibrous web as classified in the preamble of claim 1 and also to a roll cover obtained by such a method and as classified in the preamble of claim 9.

The use of fiber-reinforced and filled epoxy resins for calendar covers and other abrasion-resistant roll covers for application in the paper industry and similar applications is well-established prior art.

The proportions of fillers used are always a compromise between the various requirements of the cover. A very high fill level is desirable to achieve a very high abrasion resistance and the desired high compressive modulus.

The surface roughness which comes about in use limits in particular the amount of hard, abrasion-resistant fillers in a median particle size >0.5 μm or the resulting surface is excessively rough and has an adverse effect on the desired calendaring of the paper.

Furthermore, there are certain limits where an increasing filler content will lead to an increasing embrittlement of the material and hence to an increasing risk of massive damage in the event of local overloading or thermal stresses.

It is known from EP 1 612 329 B1, for example, that the use of particles having particle sizes in the single-digit to low triple-digit nanometer range, alone or combined with larger particles, is able to shift these limits, to a certain degree, in the desired direction.

An essential prerequisite here for achieving the desired properties is a very uniform distribution of the filler particles in the matrix and, in particular, the avoidance of agglomeration.

Filler particles, in particular filler particles having median particle sizes in the range from 1 to 100 nm (D50), are typically produced by various methods such as, for example, the sol-gel process, via specific grinding processes or by deposition from gas phases and then mixed into the resin matrix or its monomeric or oligomeric precursors.

Since the appearance of agglomerates of filler particles during the manufacture of products from filled composites can only be controlled, if at all, at unacceptable cost and inconvenience in quality assurance, the problem addressed by the invention is that of devising a method of producing a roll cover without the filler particles agglomerating to any noticeable extent, if at all.

The invention provides by way of solution that the filler particles are produced in a component of the resin matrix and/or introduced into the resin matrix from a suspension via matrix exchange, whereby the agglomeration tendency of filler particles is controlled by surface modification. The result is a stable suspension comprising a uniform distribution of filler particles.

Suspensions thus obtained of matrix material with filler particles are usually stable in storage for a prolonged period and are sufficiently quality-controllable—via the combination of various relatively simply measured criteria such as density, viscosity or opacity, for example—to identify faulty batches.

The use of thus stabilized filler particles in a resin matrix that is directly usable for the production of thermosets accordingly has enormous advantages in process consistency over the direct mixing of filler particles into a resin mixture, in particular when other, larger fillers are also used in addition.

Further advantages and developments of the invention are recited in the dependent claims.

Advantageously, the particulate filler may be precipitated in a solvent in a sol-gel process by hydrolysis in the presence of surfactants.

More advantageously, the filler may be precipitated directly in hexane by hydrolysis of tetraethoxysilane with aqueous ammonia solution in the presence of nonionic surfactants in the form of a water-in-oil emulsion.

In one preferred embodiment of the method, the precipitation reaction may be followed by stepwise admixture of one of the polymer components and evaporation of the solvent to change the liquid phase from the solvent to the polymer component.

Alternatively, the precipitation reaction may be followed by continuous admixture of one of the polymer components and simultaneous evaporation of the solvent to change the liquid phase from the solvent to the polymer component.

According to a further advantageous aspect of the invention, the filler particles may also be produced in a polymer component of the resin matrix by conducting a precipitation reaction directly in a polymer component of the resin matrix.

Furthermore, the method additionally or alternatively provides the step of surface modifying the filler particles in a polymer component of the resin matrix. This may be used to improve the attachment of the filler particles to the polymer component of the resin matrix.

Preferably, the surface modification of SiO₂-containing filler particles may be effected with epoxysilane or poly(L-lactide).

Preferably, the filler particles have median particle sizes in the nanometer range (1 to 100 nm (D50)).

In an advantageous embodiment of the invention, the filler particles may be selected from: oxides, carbides, nitrides, aluminosilicates, silicates, sulfates, carbonates, phosphates, titanates, carbonanotubes, carbonanofibers, metals of preferably synthetic origin or mixtures thereof.

In one advantageous development of the invention, the filler particles may be surface modified, in particular with poly(L-lactide)-coated SiO₂. This gives improved attachment to the resin matrix.

Advantageously, the resin matrix may comprise a thermoset, in particular an amine- or anhydrate-crosslinked or self-crosslinking epoxy resin or an isocyanate ester or mixtures thereof.

Preferably, the filler content of the resin matrix may be between 0.5 and 30 volume percent. This makes it possible to achieve the properties desired for the roll cover without the roll cover embrittling.

The invention will now be more particularly described.

Calendars or calendaring units for fibrous webs such as webs of paper or of board have the office to calendar the fibrous web either directly following its production (online) or else at a later date (offline). To discharge this office, the covers on the rolls in the calendar have to meet very high requirements with regard to both their surface finish and their resistance to thermal and mechanical stresses.

It is customary for a calendar to have two or more rolls arranged in the form of a stack, one common embodiment of which has a metallic heatable roll paired with an unheated resilient roll to form a nip. Initially, a first side of the fibrous web is calendared under heat and pressure in two or more successive nips. A supercalendar or multinip calendar will usually have a so-called reversing nip located roughly in the middle of the stack, whereafter the other side of the fibrous web comes into contact with the calendaring hot rolls.

The roll covers of unheated rolls usually consist of one or more or else often of two or more layers of diverse materials such as rubber, polyurethane or fiber-reinforced plastics applied to a roll body. Fiber-reinforced plastics are usually the material of choice for application in a calendar, since they possess a high level of thermal resistance and also a high level of mechanical strength and a good level of abrasion resistance.

Such plastics usually comprise a resin matrix and also an embedded fibrous reinforcement of glass, carbon or aramid fibers or similar other suitable fibers as reinforcement. The production of roll covers of this type is well known, so only a short summary will be provided here.

Production may proceed in accordance with diverse existing processes. One possibility is to wind the fibers dry and to apply the resin matrix by casting. Another common process provides that fiber bundles, for example those known as rovings, be pulled through a resin bath comprising the resin matrix and then be wound up wet onto the roll body. Injection-molding processes wherein the matrix material is applied to a rotating roll body via axially displaceable dies are also ii known and suitable for producing a roll cover of the present invention.

Construction may be single- or multi-layered, while further layers such as, for example, a base layer, designed to provide adherence between the roll core and the roll cover, and additional tie-layers may also be provided. The measures of the present invention relate to a roll cover functional layer that contacts the fibrous web.

Useful resin matrices include amine-crosslinked, anhydride-crosslinked or else self-crosslinking epoxy resins, isocyanate esters or other thermosets or mixtures thereof.

Whichever method is used, it is possible and customary to fill the resin matrix with fillers to thereby improve its mechanical and thermal properties.

The fillers which are dispersed according to the present invention with particle sizes in the nanometer range may be oxides, carbides, nitrides, aluminosilicates, silicates of preferably synthetic origin, but also sulfates, carbonates, phosphates, titanates, carbonanotubes, carbonanofibers, metals or mixtures thereof.

The filler particles may be used with or without surface modification, for example with poly(L-lactide)-coated SiO₂ for better attachment to the resin matrix.

What is essential is that the filler particles were produced in the resin matrix and/or introduced into the resin matrix from some other suspension via matrix exchange. Alternatively, surface modification of the filler particles may also be effected in the suspension after they have been mixed into it.

Various methods are conceivable for this and will now be presented.

For example, nanoscale silicon oxide may be precipitated, for example directly in hexane or some other suitable solvent, in a sol-gel process by hydrolysis of silanes, e.g., tetraethoxysilane, with an aqueous ammonia solution, for example, in the presence of surfactants, for example nonionic surfactants, in the form of a water-in-oil emulsion. The particles formed are stabilized by an enveloping layer of surfactants and thereby have a uniform particle size and an extremely low tendency to agglomerate. Stepwise admixture of one of the polymer components and evaporation of hexane is used to change the liquid phase from hexane to the polymer component without the nanoscale particles having to be separated off and redispersed. This method of production is also known as matrix exchange.

Alternatively, the admixture of the polymer component and the evaporation of the solvent may take place continuously and simultaneously.

In a further process, the above-described precipitation reaction may be conducted directly in the polymer component chosen. The matrix exchange step is omitted in this case.

In a further advantageous process, nanoparticles obtained by an existing process are dispersed in a solvent or a polymer component and then a surface modification is carried out. This also reduces the agglomeration tendency of the particles.

It is also possible in principle, however, for particles whose agglomeration tendency has been reduced by modifying the particle surface with, for example, epoxy-functionalized silanes or poly(L-lactide) to be mixed into the resin matrix directly, without matrix exchange. The surface modification additionally improves the attachment to the matrix and hence enhances the efficacy of the particles.

It is further possible for further filler particles especially with other median particle sizes to be introduced into the suspension in order to modulate the property profile of the roll cover accordingly.

1-13. (canceled)

14. A method of producing a roll cover, the method comprising:
forming the roll cover with at least one layer consisting of a resin matrix and filled with at least one particulate filler; and
producing filler particles for the filler in a component of the resin matrix and/or introducing the filler particles into a polymer component of the resin matrix from a dispersion via matrix exchange.

15. The method according to claim 14, which comprises forming the roll cover for use in a machine for producing and/or processing a fibrous web including web of paper or of card board,

16. The method according to claim 14, which comprises precipitating the particulate filler in a solvent in a sol-gel process by hydrolysis in the presence of surfactants.

17. The method according to claim 16, which comprises precipitating the filler directly in hexane by hydrolysis of tetraethoxysilane with aqueous ammonia solution in the presence of nonionic surfactants in the form of a water-in-oil emulsion.

18. The method according to claim 16, wherein a precipitation reaction is followed by stepwise admixture of one of the polymer components and evaporation of the solvent to change a liquid phase from the solvent to the polymer component.

19. The method according to claim 16, wherein a precipitation reaction is followed by continuous admixture of one of the polymer components and simultaneous evaporation of the solvent to change a liquid phase from the solvent to the polymer component.

20. The method according to claim 14, which comprises producing the filler particles in a polymer component of the resin matrix by conducting a precipitation reaction directly in a polymer component of the resin matrix.

21. The method according to claim 14, which further comprises surface modifying the filler particles in a polymer component of the resin matrix.

22. The method according to claim 21, wherein a surface modification of SiO₂-containing filler particles is effected with epoxysilane or poly(L-lactide).

23. A roll cover, comprising:
at least a layer of a resin matrix filled with at least a particulate filler, the particulate filler having been produced by the method according to claim 14.

24. The roll cover according to claim 24, configured for a machine for producing and/or surface finishing a fibrous web.

25. The roll cover according to claim 23, wherein said filler particles are selected from the group of materials consisting of oxides, carbides, nitrides, aluminosilicates, silicates, sulfates, carbonates, phosphates, titanates, carbonanotubes, carbonanofibers, metals of synthetic origin and mixtures thereof.

26. The roll cover according to claim 23, wherein said filler particles are present in a particle size of from 1 to 100 nm (D50).

27. The roll cover according to claim 23, wherein said resin matrix comprises a thermoset.

28. The roll cover according to claim 27, wherein said resin matrix is an amine-crosslinked or anhydrate-crosslinked or self-crosslinking epoxy resin or an isocyanate ester or mixtures thereof.

29. The roll cover according to claim 23, wherein a filler content of said resin matrix lies between 0.5 and 30 volume percent.
